(19) United States
(12) Patent Application Publication
(10) Pub. No.: US 2026/0178713 A1
(43) Pub. Date: Jun. 25, 2026

(54) DETECTING UNAUTHORIZED ASSISTANCE TO USER DURING ONLINE LEARNING SESSION USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Pedro Ricardo Gomes Dias, Hong Kong (CN); Zoltan Szalontai, Kecskemét (HU); Ishan Tripathi, Noida (IN); Gaurav Shukla, Calgary (CA)

(73) Assignee: 2hr Learning, Inc., Austin, TX (US)

(21) Appl. No.: 19/390,216

(22) Filed: Nov. 14, 2025

Related U.S. Application Data
(60) Provisional application No. 63/720,183, filed on Nov. 14, 2024.

(51) Int. Cl. G06F 21/31; G06V 40/16; G10L 15/26

(52) U.S. Cl. CPC G06F 21/316; G06V 40/172; G10L 15/26

(57) ABSTRACT

A real-time AI-based cheating detection system and process for detecting unauthorized assistance during online learning sessions. The process begins by receiving input data from user device. The input data is pre-processed to ensure user is on a valid online learning platform and enrolled in the correct program. If validation is successful, the data is sent for further analysis. Proving one or more prompts a plurality of AI tools for specific tasks. The system and process employ visual recognition algorithm to detect additional individuals in the webcam feed, audio analysis algorithm to identify multiple voices of unauthorized help, and screen activity analysis algorithm to uncover anomalies during the session. Upon detecting unauthorized assistance, AI-based cheating detection systems and process compiles evidence, including video feeds and textual AI-generated transcripts of the session. Moreover, triggers an alert to the user containing compiled evidence and summary of the detected behavior along with timestamps.

### CROSS-REFERENCE TO RELATED APPLICATION(S)

This application claims the benefit under 35 U.S.C. § 119(e) and 37 C.F.R. § 1.78 of U.S. Provisional Application No. 63/720,183, which is incorporated by reference in its entirety.

### FIELD OF THE INVENTION

The present invention relates in general to the field of electronics and more specifically to real-time AI-based cheating detection systems and real-time AI-based cheating detection processes that automatically generate, and store evidence clips to detect potential cheating instances or unauthorized assistance to users during online learning sessions.

### BACKGROUND OF THE INVENTION

Examinations, typically conducted in person under the direct supervision of teachers or invigilators, aim to ensure integrity and minimize instances of cheating. However, this traditional framework often prioritizes strict structure, characterizes by fixed locations, timings, and rigid guidelines over adaptability, highlighting the need for more flexible methods in evolving online education scenarios.

As education increasingly shifts online, examinations have also transitioned to digital platforms. However, this shift brings significant challenges, particularly in monitoring students and detecting dishonest practices. Tools for detecting plagiarism in assignments and exams provide some assistance, and certain educational platforms analyze student response patterns to detect anomalies. Yet, these methods are confined to specific assessment periods and do not extend to interactive or live learning environments.

Manual remote proctoring, another widely used method for cheating detection, involves monitoring students through video feeds. While feasible on a small scale, this approach is labor-intensive and becomes impractical as the number of students increases. It requires a proportional increase in human resources as the number of students grows, leading to higher operational costs. Furthermore, manual processes are prone to slower response times, human error, and inconsistencies in monitoring standards.

As online examinations grow in prevalence, the need for efficient, transparent, and reliable proctoring systems has become critical. These systems must effectively monitor unauthorized assistance, document instances of cheating, and uphold the credibility of online education. By addressing online cheating challenges, robust proctoring solutions can ensure fairness and build trust in the digital learning landscape.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary real-time AI-based cheating detection system that automatically generates and stores evidence clips using webcam video, microphone audio, and screen capture feeds.

FIG. 2 depicts an exemplary real-time AI-based cheating detection process utilized by the real-time AI-based cheating detection system of FIG. 1.

FIGS. 3A-3G (collectively referred to as FIG. 3) collectively depict an exemplary real-time AI-based cheating detection process workflow that includes the components involved in automatically generating and storing evidence clips using multimodal data analysis, which is an embodiment of the real-time AI-based cheating detection process of FIG. 2.

FIG. 4 depicts an exemplary snapshot of the learner's webcam which shows that the learner is assisted by an adult while working on mastering skills.

FIG. 5 depicts an exemplary StudyFilm cheating detection process workflow that includes the function calls involved in automatically generating, storing, and analyzing evidence clips, which is an embodiment of the real-time AI-based cheating detection process of FIG. 2.

FIG. 6 depicts the sequence diagram for generating alerts, which is an embodiment of the AI-based cheating detection process of FIG. 2.

FIG. 7 depicts an exemplary data structure for the real-time AI-based cheating detection system in online learning environments incorporating multimodal data analysis using webcam, microphone, and screen capture.

FIG. 8 depicts an exemplary network environment in which the system of FIG. 1 and the process of FIG. 2 may be practiced.

FIG. 9 depicts an exemplary computer system.

### DETAILED DESCRIPTION

A real-time artificial intelligence (AI) based cheating detection system that automates the generation and storage of clips from multiple data sources when an instance of unauthorized assistance is identified, is described. The data sources include webcam videos, microphone audio, and screen capture. The real-time AI-based cheating detection system is not only useful in its seamless feature of accurate incident reporting, but it also reduces the burden on the administrators and educators to manually monitor instances of unauthorized assistance. The AI-based cheating detection system aims to maintain a high standard of academic integrity in the educational environment. The AI-based detection system is typically applicable for online educational platforms facilitating its scalable deployment in large educational settings. It further allows unbiased contextually relevant incident reporting and archiving features.

The real-time AI-based cheating detection system consists of a user device that facilitates online learning through an online learning platform. The user interacts with this online learning platform through a user interface. The user devices may include desktop computer systems, laptops, and mobiles utilizing the data sources for online learning. The feeds from the webcam, screen share, microphone, and system audio are fed as input to a data extractor tool. The data extractor tool parses this input data. It then initiates a continuous transfer of this parsed data to an analyzer and cloud storage. This continuous transfer of parsed data occurs in fixed intervals of time. The data extractor tool transfers the details of the user's login credentials and Uniform Resource Locator (URL) associated with the online learning application to the analyzer in fixed intervals. The data extractor also transfers 5-second clips from the data sources to a cloud storage.

The analyzer processes the received information and deploys additional checks before initiating the cheating detection flow. The checks include ensuring that the user or student or learner is correctly enrolled in the listed online learning platform and is active. If the results of these checks are true, then it initiates the cheating detection process. The analyzer then initiates the download of all the 5-second clips of all the data sources from the cloud storage. The analyzer further extracts and transfers the first one-second frame of the 5-second clips to an AI engine, with specific prompts. The prompts are tailored specifically to process and analyze different categories of input. There are separate prompts for analyzing video feeds, microphone, and system audio feeds and for validating the analysis of video and audio feeds.

Within the AI engine, the video feed analysis is performed to detect if there is any interaction between the user and any other person. If there is no indication of any interaction between the user and the other person, then the detection process is stopped. If there is an indication of any interaction, then the microphone and system audio feeds for the given 5 seconds are sent for translation and transcript generation and analysis. The audio feed analysis and transcript generation tool checks for the presence of multiple voices including the voices from a speaker within the user device. It also checks if there is any interaction between the user, the system audio, and any other person in any language. Following the audio analysis, the script generation tool then generates a transcript recording of the conversational details tagged with the speaker's identity whether it is a student, computer, or adult, and the respective timestamp. Further, the generated transcript and the frames of both the webcam and screen share feeds are transferred to a quality analysis AI tool for validating the analysis made by the video feed analysis tool and the audio feed analysis and transcript generation tool. If the quality analysis tool disagrees with the detection, then the cheating detection process is stopped. If detection is validated, the analyzer triggers a response to record the cheating detection as an antipattern in an evidence database. All the screenshots with the respective timestamps corresponding to the recorded antipattern are then stored in the cloud storage. The analyzer further checks for any cheating violation within the last two minutes of the first instance of cheating detection. If a cheating detection is encountered, then the analyzer triggers a response to a data compiler to merge all the clips from the data sources within the previous two minutes from the cloud storage. The data compiler further updates the evidence database with updated antipattern evidence including textual AI descriptions corroborating the cheating behavior including evidence for repeated instances of unauthorized assistance.

When unauthorized assistance is validated, the analyzer triggers a response to the evidence database to transfer the evidence details to a notification module. The notification module is further utilized for the generation of an alert back to the user interface. The alert is presented on the screen of the user in the form of a blocker overlay. The overlay contains screenshots indicating unauthorized assistance for the recorded antipattern. The overlay further displays action items to be performed by the user in the form of two user interface buttons. One button has an option for the user to accept the violation and acknowledge the responsibility for not repeating the same. The other button provides the user with the option to dispute the violation. In both instances, the user response is recorded. Additionally, the disputed responses are stored in the evidence database for further monitoring and analysis.

The system and method set forth herein address technical issues with generating the desired outputs described herein. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

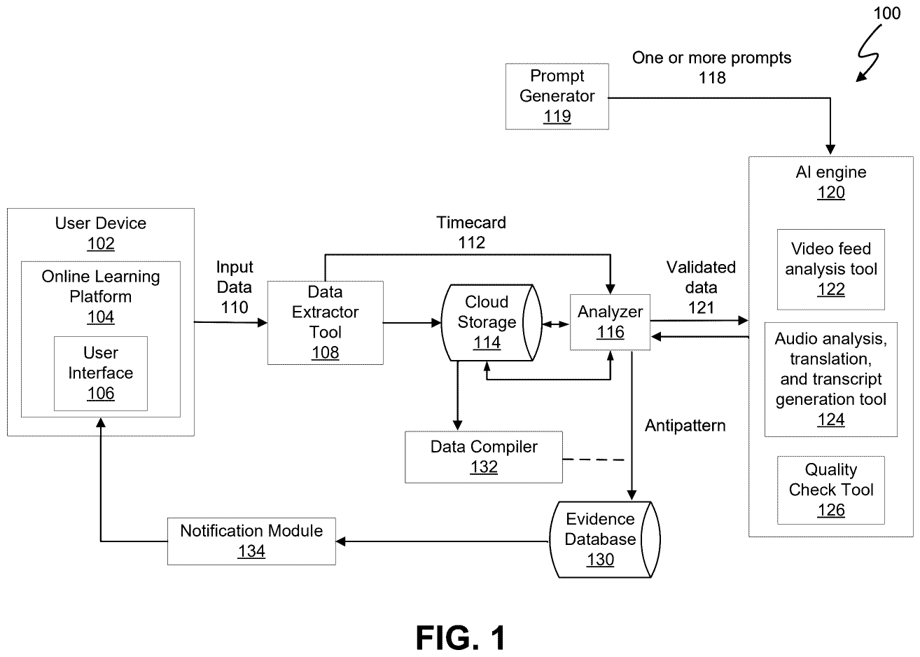

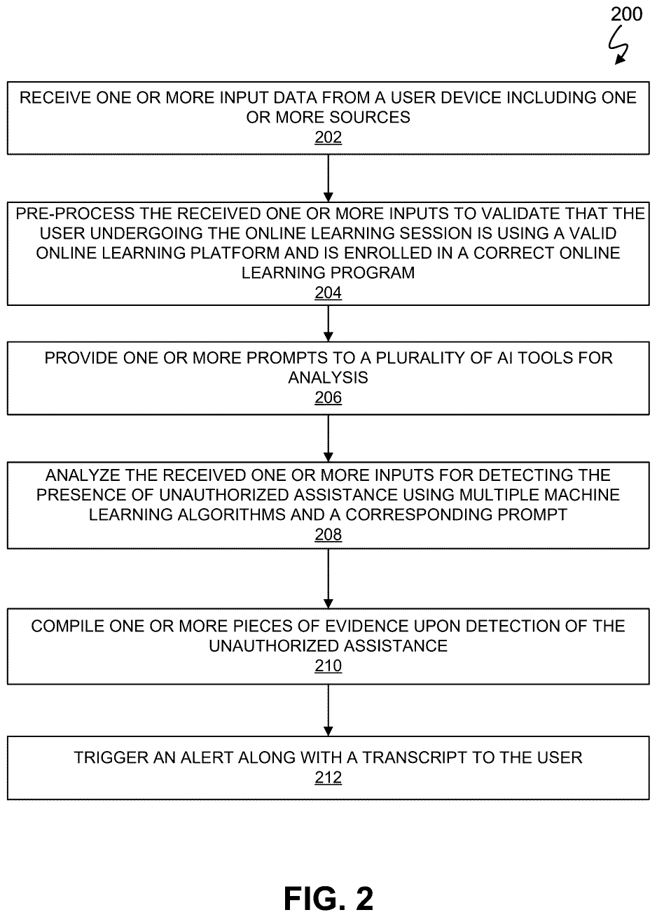

FIG. 1 depicts an exemplary real-time AI-based cheating detection system 100 that automatically generates and stores evidence clips using webcam video, microphone audio, and screen capture feeds. FIG. 2 depicts an exemplary real-time AI-based cheating detection process 200 utilized by the real-time AI-based cheating detection system of FIG. 1.

The real-time AI-based cheating detection system 100 includes a user device 102 such as a desktop computer system, a laptop, a mobile device, or so forth. The user device 102 is equipped with tools such as a webcam, microphone, and screen capture for recording video, audio, and displayed data respectively. The user device 102 provides access to an online learning platform 104 with a built-in user interface 106. Examples of online learning platforms 104 include Duolingo and Khan Academy. The user interface 106 provides access through which the user interacts with the online learning platform 104.

The user device 102 transfers the input data 110 to a data extractor tool 108. The input data 110 consists of the webcam, microphone, system audio, and screen share feeds. The data extractor tool 108 is a software tool designed to record input from multiple sources and then parse them for further processing. The data extractor tool 108 sends the user login and URL details to an analyzer 116 every minute through a timecard 112. The timecard 112 refers to an information packet that contains all the required information to validate the user activity on the online learning platform 104. A URL (Universal Resource Locator) denotes a web address that is used to access a website or resource on the internet. The analyzer 116 is a software tool that takes inputs from multiple sources and triggers actions for processing the data transferred to it. The data extractor tool 108 also continuously shares 5-second clips of the webcam, microphone, system audio, and screen share feeds to a cloud storage 114. The cloud storage 114 refers to a remote data storage repository on the internet that is used to store digital information. This digital information can be easily accessed and shared from anywhere.

The analyzer 116 on receiving the user login and URL details along with timecard 112 performs a few checks before invoking the cheating detection process. The analyzer 116 first checks if the user is enrolled in a learn-and-earn program. Then the analyzer 116 checks if the URL data contains valid learning applications. Further, the analyzer 116 checks if the user is not inactive. These checks are implemented by the analyzer 116 to reduce the false positive instances. Once all the checks return a positive response, the analyzer 116 triggers the cheating detection process.

The analyzer 116 first downloads all the 5-second clips of the webcam and screen share feed of the user within the last minute from the cloud storage 114. Further, the analyzer 116 also downloads all the 5-second microphone and system audio feeds within the last 2 minutes from the cloud storage 114. Then the analyzer 116 extracts the first frame from each of the webcam and screen share feed. All the data which the analyzer 116 downloaded from the cloud storage including the extracted frames from the webcam and screen share feed is transferred as input to an AI engine 120 with one or more prompts (“prompt(s)”) 118. The data transferred as input to the AI engine 120 is designated as validated data 121 and prompt(s) 118. The AI engine 120 is a framework designed to process and analyze complex information in software applications to generate intelligent behavioral mechanisms. The AI engine 120 integrates the plurality of AI tools to perform tasks that typically require human-level intelligence. To perform complex tasks, the AI engine 120 incorporates one or more Large Language Models (LLMs). The LLMs are trained on vast amounts of data which is used to understand and generate human-like text. The LLMs enable the AI engine 120 to perform a multitude of tasks such as automatic content generation, facial and voice recognition, natural language processing, and text summarization.

The AI engine 120 performs multiple functions represented by the plurality of AI tools with each component capable of processing the input data 110 guided by the prompt(s) 118. The AI engine 120 is guided and constrained by the one or more prompts to virtually implement a video feed and analysis tool 122, an audio analysis, translation, and transcript generation tool 124, and a quality check tool 126. The prompt(s) 118 transferred to the AI engine 120 enables the AI engine 120 to process the transferred data in a tailored and structured manner as represented by the plurality of AI tools. Each prompt from the prompt(s) 118 directs a specific AI tool of the AI engine 120 to adhere to specific guidelines and generate output in a prescribed format.

The video feed analysis tool 122, checks for the presence of any other individual alongside the user under certain circumstances. If there is no individual in the background or if the individual in the background is not interacting with the user, then the detection process is stopped, and no action is taken. There are two exemplary instances where the video feed analysis tool 122 may necessitate further action. First, the video feed analysis tool 122 detects an individual in the foreground with the user who may or may not be interacting with the user or looking at the screen or the webcam. Secondly, the video feed analysis tool 122 detects an individual in the background either looking at the screen or webcam or interacting with the user or any combination of actions. In either of these instances, the analyzer 116 triggers the merging of the 5-second clips of the microphone and system audio feeds which is transferred to the audio analysis, translation, and transcript generation tool 124 along with the specified prompt from the prompt(s) 118. The audio analysis, translation, and transcript generation tool 124 checks for the presence of multiple voices including the system sounds within the audio. It further checks if there is audio in languages other than English in the microphone and system audio feeds. If a different language is detected, then the audio analysis, translation, and transcript generation tool 124 that converts audio into English language. Finally, a transcript is generated by the audio analysis, translation, and transcript generation tool 124 for the merged microphone and system audio feed. It also identifies if a speaker is a student, a computer or an adult.

The generated transcript along with the extracted frames of the webcam and screen feeds are fed as input to the quality check tool 126. The quality check tool 126 checks for the validity of the preliminary analysis done by the video feed analysis tool 122 and the audio analysis, translation, and transcript generation tool 124. If the quality check tool 126 disagrees with the preliminary analysis, then the cheating detection process is stopped. If the quality check tool 126 approves the preliminary analysis, then the analyzer 116 triggers a response to record the antipattern 128 for the particular minute in the evidence database 130. Additionally, all the screenshots associated with the antipattern 128 for the given minute are uploaded to the cloud storage 114. The analyzer 116 further checks if there is any other instance of the antipattern 128 in the last 2 minutes. If such an instance is found, then the same process of recording the screenshots in the cloud storage 114 and storing the antipattern 128 in the evidence database 130 is initiated with additional actions. The analyzer 116 triggers a data compiler 132 to implement additional actions. The data compiler 132 is a software tool that is designed to gather the details of the generated antipattern 128. The additional actions include changing the URL status of the clip associated with the first instance of the recorded antipattern 128 to IN_PROGRESS. The data compiler 132 further merges the webcam, screen share, microphone, and system audio feeds for the previous 2 minutes and then updates the clip URL in the evidence database 130 from IN_PROGRESS with the URL of the merged clip. The data compiler 132 further stores the compiled data in the evidence database 130.

If the cheating activity is encountered, the analyzer 116 triggers the transfer of gathered evidence for the detected antipattern 128 from the evidence database 130 to a notification module 134. The notification module 134 upon receiving the evidence from the evidence database 130 generates an alert back to user interface 106. The alert manifests as a blocker overlay on the user screen. The overlay consists of screenshots of the detected antipattern 128 along with an additional text description mentioning the ramifications of the identified cheating action. The overlay also contains two action buttons. The first button is for acknowledging the cheating detection and accepting responsibility for it. The second button is for disputing the cheating detection. In both cases, the user response is recorded. Additionally, in case of a disputed violation, it is stored in the evidence database 130 for further investigation.

Referring to FIGS. 1 and 2, in operation 202, receiving input data 110 from the user device 102 including one or more sources. The user device 102 includes but is not limited to a desktop personal computer, a laptop, or a mobile device. Additionally, the user device 102 features a web camera, a microphone, and a screen. The web camera, microphone, and screen may be integrated within the user device 102 as in the case of mobile devices and laptops. If the user device 102 is a desktop personal computer, the web camera, and microphone may be externally connected to it. Within the user device 102, the online learning platform 104 is available to access. The online learning platform 104 represents software that allows users to access educational resources, software tools, courses over the internet and the like. The online learning platform 104 allows the learners such as user, student, teacher or so forth to gain knowledge and necessary skills in a remote manner. The online learning platform 104 offers features such as interactive content, video lessons, quizzes, and progress tracking. Examples of online learning platforms 104 include but are not limited to Coursera, Udemy, Khan Academy, and Moodle. The online learning platform 104 is mainly used for academic learning, personal and professional skill development, and fostering lifelong learning through accessible and flexible education.

The online learning platform 104 features the user interface 106. The user interface 106 acts as a medium through which the user can interact with the online learning platform 104. The user includes but is not limited to any student or learner. The user interface 106 includes multiple elements that help ease the interaction between the user and the online learning platform 104. The elements incorporated by the user interface 106 include but are not limited to navigation menus, dashboards, interactive tools, and multimedia interfaces. The navigation menus allow access to courses, modules, and settings. The dashboard allows tracking of user progress while learning and content management. The interactive tools include discussion forums for different students to discuss queries related to course content. Additionally, the discussion forums include quizzes and sections for uploading assignments.

The user interface 106 incorporates input devices such as a webcam and microphone along with the display screen as a part of the learning environment within the online learning platform 104. This integration of the webcam, microphone, and display screen is done to ensure that any user, particularly the student, is complying with the honor code policies of the online learning platform 104 during a live evaluation session. The honor code policies are a set of ethical guidelines that the user(s) are expected to follow to maintain academic integrity within the learning environment. The honor code policies prohibit any user from seeking unauthorized assistance from any person or external materials. The external materials may include books or online learning resources relevant to the content of the live lesson when the users are recording their responses via audio or text channels. Additionally, the honor code policies include expectations from the users to upload original assignment work that is free from plagiarism.

The real-time AI-based cheating detection system 100 allows the input data 110 from the user device 102 to be fed into the data extractor tool 108. The input data 110 consists of the webcam feed, microphone feed, and live screen-sharing feed from the user device 102. The webcam feed is a stream of live video that is recorded by the webcam. The webcam feed depicts real-time visuals of a user or any background object in front of the camera. The webcam feed helps in identifying the presence of any other person in the foreground or background of the user. The webcam feed helps detect any unusual physical movements of the user and the other person or individual. This anomalous behavior includes but is not limited to fidgeting or unusual facial movements and expressions by the user, the other person, or both. The microphone feed consists of the live audio generated from the microphone in response to an input sound. These input sounds include but are not limited to user speech, the speech of any other person in the foreground or background or any other environment sounds such as the sound of rainfall, or birds chirping or rustling of leaves as wind passes through them. The microphone feed is also merged with the audio feed of the user device 102. This audio feed includes any notification sound generated by the user device 102, or the audio of any other person speaking on the user device 102 screen. Additionally, the audio feed may also include the audio from any learning application such as Duolingo or Coursera. The screen share feed includes streaming or sharing all the content that is visible on the screen of the user device 102 in real-time. This allows any external agency, such as other computer systems or individuals connected via conference tools like Zoom or Skype, to view the content displayed on the screen of the user device 102. Additionally, the screen share feed can also depict real-time cursor activity with click indicators including annotations or drawings created using a pointer or tool.

The data extractor tool 108 enables recording and parsing of the input data 110 in real-time for further processing. The data extractor tool 108 continuously transfers the parsed input data 110 to the cloud storage 114 in intervals of 5 seconds. The parsed input data 110 includes 5-second clips of the webcam, microphone, and screen shared feeds. The cloud storage 114 is defined as a remote data storage service that allows saving digital information on internet servers instead of the hard disk drives on personal computers, laptops, or mobile devices. The cloud storage 114 enables easy access and sharing of files from anywhere with an internet connection. Additionally, the data backup and maintenance are handled by the cloud storage 114 providers. Some examples of cloud storage are Amazon S3, Google Drive, and Dropbox. Additionally, the data extractor tool 108 continuously transfers the timecard 112 to the analyzer 116 every minute. The timecard 112 represents information related to the URL of the website or the software application that is being used by the user.

In operation 204, pre-processing the received input data 110 to validate that the user learning through the online learning session is using a valid online learning platform and is enrolled in a correct online learning program. The analyzer 116 refers to a software application or tool that examines and interprets the data fed into it for extracting meaningful information. The analyzer 116 checks the timecard 112 for specific details regarding the user activity on the online learning platform 104. The timecard 112 details contain the login credentials of the user including the email id. The analyzer 116 first checks if the user is enrolled in a learn and earn program through the user email ID. The learn and earn programs are learning programs that are designed to provide the users with the opportunity to gain valuable skills while earning credits or monetary benefits. The learn-and-earn program reward the users with credits, discounts, or rewards for completion of certain skill-building exercises or certifications. The goal of the learn and earn program is to offer flexible learning opportunities while offering tangible benefits to the users. This fosters continuous learning and assists new users in applying their acquired skills in real-world contexts and boosts their career growth prospects. The analyzer 116 further checks if the URL activity of the user contains the permitted leaning applications such as Khan academy or Duolingo and finally checks if the user is not idle. These checks are performed to validate the presence of the user who is supposed to be present on the online learning platform 104 and eliminate the generation of false cheating detections. If the user is utilizing the user device 102 for personal work which is corroborated with the timecard 112 for the particular minute, then that minute is ignored. The checks also monitor the activity status of the user. The inactive state of the user is indicated by no mouse or keyboard activity even if there are other individuals or people in the foreground or background. If the checks confirm user inactivity, then the particular minute or duration is ignored.

If the analyzer 116 receives the results of the performed checks as true, then it generates a trigger response to initiate the cheating detection process. The analyzer 116 then gathers the meeting ID and the timecard 112 which includes the online learning application URL data, user email ID, and other related content metadata. The analyzer 116 further uses the meeting ID and timecard 112 to download the 5-second clips of the webcam and screen share feeds for the previous minute from the cloud storage 114. Additionally, the analyzer 116 also downloads the 5-second microphone and system audio feeds within the previous 2 minutes from the cloud storage 114. The analyzer 116, then extracts the first frame of each webcam and screen feed clip before transferring the downloaded data to the AI engine 120.

The analyzer 116 transfers the information gathered from the cloud storage 114 to the AI engine 120 as validated input along with the prompt(s) 118. The input to the AI engine 120 from the analyzer 116 is validated data 121 and the prompt(s) 118. The AI engine 120 is designed for implementing complex tasks such as data processing, decision making, and problem solving in artificial intelligence applications. The AI engine 120 typically leverages one or more Large Language Models (LLMs). The LLMs are trained on a vast amount of text data and are capable of understanding and generating human-like language. The LLMs use natural language processing capabilities that enable them to perform a wide variety of tasks such as automatic text generation, language translation, summarization, sentiment analysis and so forth. Furthermore, the LLMs are capable of continuously improving their responses through fine-tuning. These features of Large Language Models allow the AI engine 120 to deliver more intuitive and context-aware responses to user inputs. The LLMs include but are not limited to Claude 3.5 Sonnet, Gemini owned by Google, and GPT 4o owned by OpenAI.

In operation 206, providing prompt(s) 118 via a prompt generator 119 to the AI engine 120. The prompts are defined as a set of specific instructions for guiding the AI engine 120 to process the validated data 121 based on predefined conditions. The prompt(s) 118 are tailored by the prompt generator 119 specifically to process the webcam feeds, microphone and system audio feeds, and the screen share feeds within the validated data 121. Each prompt from the prompt(s) 118 is detailed and nuanced to minimize any possibility of the generation of false detection. This means that the prompt(s) 118 capture nearly every possible scenario or instance within each of the webcam, screen share, microphone, and system audio feeds. This enables the AI engine 120 to objectively ascertain whether there is an instance of cheating. Additionally, the prompt(s) 118 also contains instructions to transcribe the audio from all languages other than English and convert them to English language before processing them for any possibility of cheating. The prompt(s) 118 further specifies the format of the output that is required to be generated after the AI engine 120 utilizes the plurality of AI tools to process the validated data 121. In at least one embodiment, the prompt(s) 118 are provided by a prompt engineer. The prompt engineer prepares the schema or skeleton of the prompt(s) 118 and are further provided to the prompt generator 119.

In operation 208, analyzing the received input data 110 for detecting the presence of unauthorized assistance using the plurality of AI tools guided using the prompt(s) 118. The information within the input data 110, the validated data 121 and the prompt(s) 118 transferred to the AI engine 120 is selectively utilized by the plurality of AI tools of the AI engine 120. The AI engine 120 consists of three components, the video feed analysis tool 122, the audio analysis, translation and transcript generation tool 124, and the quality check tool 126. Each AI tool is tasked with performing specified checks to detect the presence of unauthorized assisting the AI engine 120. The video feed analysis tool 122 captures the extracted frames from the webcam feed along with the section of the prompt tailored for webcam feed analysis. The video feed analysis tool 122 uses a visual recognition algorithm to detect the presence of multiple people including the user within the webcam feed. The purpose of the video feed analysis tool 122 is to first detect if any other person, presumably an adult, is present alongside the user either in the foreground or background. In case the other person is present, the video feed analysis tool 122 further checks if the person is looking at the user, the webcam, or the screen or is engaged in any other activity with the user. The video feed analysis tool 122 identifies different individual appearances based on their position on the screen. The frames of the webcam feed include the foreground and the background. The tool additionally identifies behavioral patterns such as eye and face movements, body posture, and hand gestures. These patterns indicate user engagement with the screen. Based on the analysis, a response is generated by the video feed analysis tool 122. This response based on the expected outcomes is either returned to analyzer 116 or it may trigger further analysis by the other components of the AI engine 120. If the video feed analysis tool 122 detects that no person is present, then it returns the response to the analyzer 116 indicating no further action. If the video feed analysis tool 122 detects that the person is present alongside the user in the background and is not engaging with the user, then also the video feed analysis tool 122 returns a response to the analyzer 116 indicating no action. The video feed analysis tool 122 may detect the presence of another person in the foreground whether engaging with the user or not or in the background engaging with either the user, the webcam, or the screen. If such an instance occurs, the video feed analysis tool 122 merges all the 5-second clips of the microphone and the system audio feeds from the input validated data 121 into a single clip. This merged single clip along with the section of prompt tailored for transcription and translation is captured by the audio analysis, translation, and transcript generation tool 124.

The purpose of the audio analysis, translation, and transcript generation tool 124 is to transcribe the audio from all the languages present within the audio feed in the merged clip and translate all of them into the English language. The audio analysis, translation, and transcript generation tool 124 uses an audio analysis algorithm to identify the speaker within the merged clip and generates the translated version of all the voices tagged with their respective speakers along with the timestamp. This merged clip may contain the voices of the user, the person alongside the user, or the voice from the user device 102. The audio analysis, translation, and transcript generation tool 124 analyzes the merged clip and returns the generated transcript with identified speakers to the analyzer 116.

The transcript generated by the audio analysis, translation, and transcript generation tool 124 along with the extracted webcam and screen share feeds is sent to the quality check tool 126 along with a section of the prompt from the prompt(s) 118 tailored for the quality check process. The quality check tool 126 utilizes a screen activity analysis algorithm to verify the preliminary analysis done by the video feed analysis tool 122 and the audio analysis, translation, and transcript generation tool 124. The verification involves utilizing the screen share feeds to understand what is happening on the screen and to further correlate the screen activity with the audio transcript. This is done to ascertain if the user is getting any assistance from the person or adult in the background. The screen share feed analysis may indicate an activity such as the detection of unauthorized applications or websites by checking the URLs that are used by the user. The screen share feed can also be used to detect anomalies in the screen behavior. For instance, the screen-shared feed would indicate rapid switching between tabs and rapid mouse clicks or movements. These actions indicate the user's effort to hide or minimize the visibility of any online source that is being used for cheating. The webcam feeds and the audio transcript can further validate if these actions are aided or unaided by the person in the background while both confirming unauthorized assistance to the user.

The quality check tool 126 analyzes the frames of webcam and screen share feeds along with the audio transcript and generates responses for the analyzer based on the predefined outcomes. If the quality check tool 126 disagrees with the preliminary analysis made by the video feed analysis tool 122 and the audio analysis, translation, and transcript generation tool 124 then no further action takes place. If the quality check tool 126 confirms the preliminary analysis, then a trigger or call is generated back for the analyzer 116. This trigger enables the recording of all the screenshots and the required details for the specific minute and designates the instance as the antipattern 128 within the analyzer 116.

The analyzer 116 on receiving the antipattern 128, further checks if there is an instance of another antipattern 128 within the previous two minutes. If the analyzer 116 ascertains that the recorded antipattern 128 marks the first instance of cheating within the previous two minutes, then the analyzer 116 stores the recorded antipattern 128 in an evidence database 130. The evidence database 130 is another cloud-based data storage platform akin to the cloud storage 114. The evidence database 130 is utilized for recording instances of the antipattern 128 along with the necessary evidence details corresponding to the antipattern 128. The analyzer further uploads all the screenshots pertaining to the antipattern 128 within the cloud storage 114. If the analyzer 116 ascertains that there was another recorded instance of the antipattern 128 within the previous two minutes, then it follows the same process of recording the antipattern 128 and its associated screenshots in the evidence database 130 and cloud storage 114 respectively with additional action items. The additional action items performed by the analyzer 116 include setting the URL of the clip for the existing antipattern 128 to IN_PROGRESS in the evidence database 130. The analyzer 116 further triggers a request to a data compiler 132.

In operation 210, compiling one or more pieces of evidence upon detection of the unauthorized assistance. The one or more pieces of evidence include the video feeds of the corresponding timestamps, textual AI-generated description of the transcript of the online learning session. Typically, for compiling one or more pieces of evidence a data compiler 132 is utilized. The data compiler 132 is a software application that upon receiving the request from the analyzer 116 downloads all the webcam, screen share and system audio feeds within the last 2 minutes from the cloud storage 114. Then data compiler 132 further merges all the feeds into a single clip and then uploads the merged clip back to the cloud storage 114 along with their associated screenshots. Additionally, the data compiler 132 also gathers the details of the first instance of the detected antipattern 128 along with the detected antipattern 128 within the last 2 minutes of the first instance if detected. These details form collective evidence to support the identification of unauthorized assistance on the online learning platform 104. The details include the video feeds along with their timestamps corresponding to unauthorized assistance, AI generated textual description of the transcript generated by the online learning platform 104. The details also include a description explaining the analysis to corroborate the detected antipattern 128. This description also contains the conclusion drawn from specific webcam frames of the video feed including the specific frame numbers. Finally, the data compiler 132 updates the URL from IN_PROGRESS state of the clip URL in the evidence database 130 with the URL of the merged clip.

The analyzer 116 transfers the details of the generated antipattern 128, if present to the evidence database 130 through the data compiler 132. The required details are then transferred from the evidence database 130 to the notification module 134 as input.

In operation, 212, triggering an alert along with a transcript to the user. To provide the alert to the user a notification module 134 is used. The notification module 134 is a software program that generates the trigger or alert response based on the received input from the evidence database 130 regarding cheating detection. The generated alert is sent back to the user device 102. The alert generated includes the compiled evidence with the summary of the behavior indicating unauthorized assistance. The summary is in the form of a transcript with additional information such as the textual transcript of the cheating timestamp at the instant or duration of the unauthorized assistance. The alert generated is displayed on the user interface 106 within the online learning platform 104 in the form of a blocker overlay. The blocker overlay is defined as a visual or functional interface element that is used by software applications and websites. This interface is used to completely block the interaction of the user with the online learning platform 104 unless the displayed information has been acknowledged or acted upon by the user. The information displayed on the blocker overlay includes screenshots citing cheating evidence and additional text-based instructions to refrain from unauthorized assistance. The text further states the ramifications of the detected activity which may include loss of learning credits or reduction in learner status in terms of a certain duration. The overlay also displays two user interface 106 buttons. The first button allows the user to acknowledge the cheating detection and accept responsibility for ensuring that the instance will not recur. The second button allows the user to report the detection as incorrect. In case the user acknowledges the cheating detection, the overlay is disabled or hidden. If the user disputes the cheating detection, the overlay is still hidden and the data extractor tool 108 triggers the analyzer 116 to record the disputed instance in the evidence database 130. The disputed instance can further be used for analysis by a monitoring team.

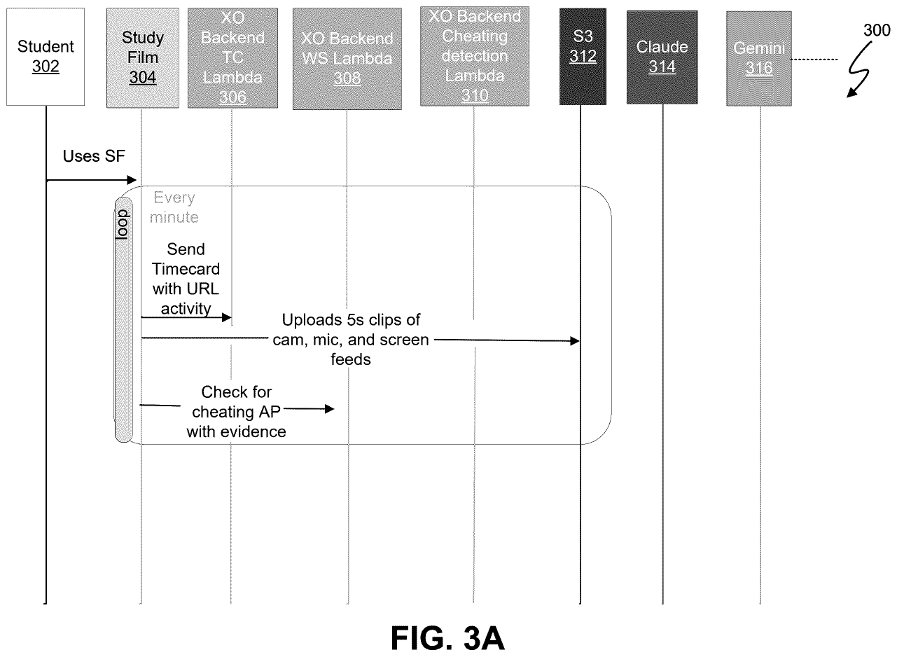

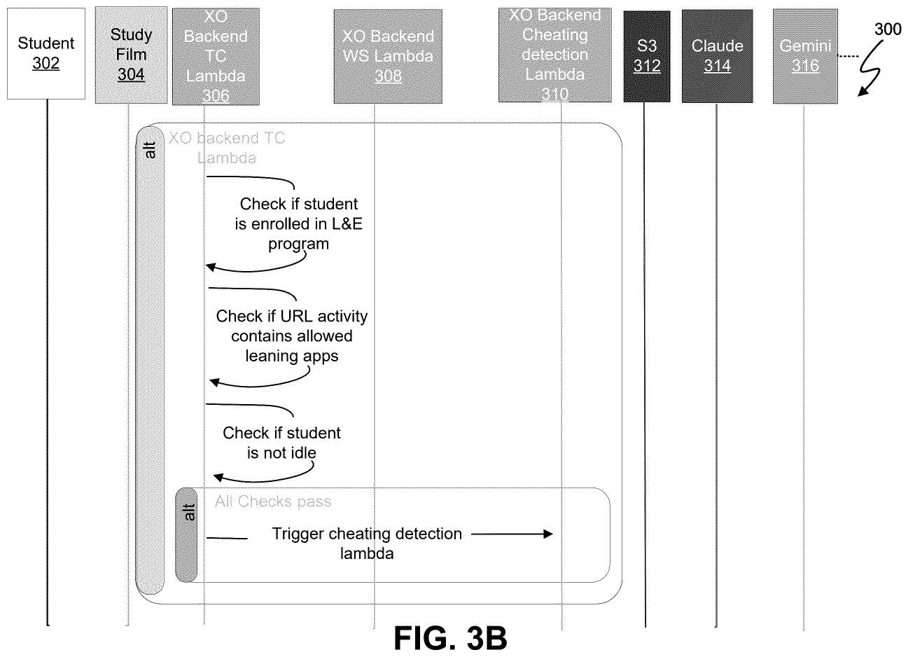

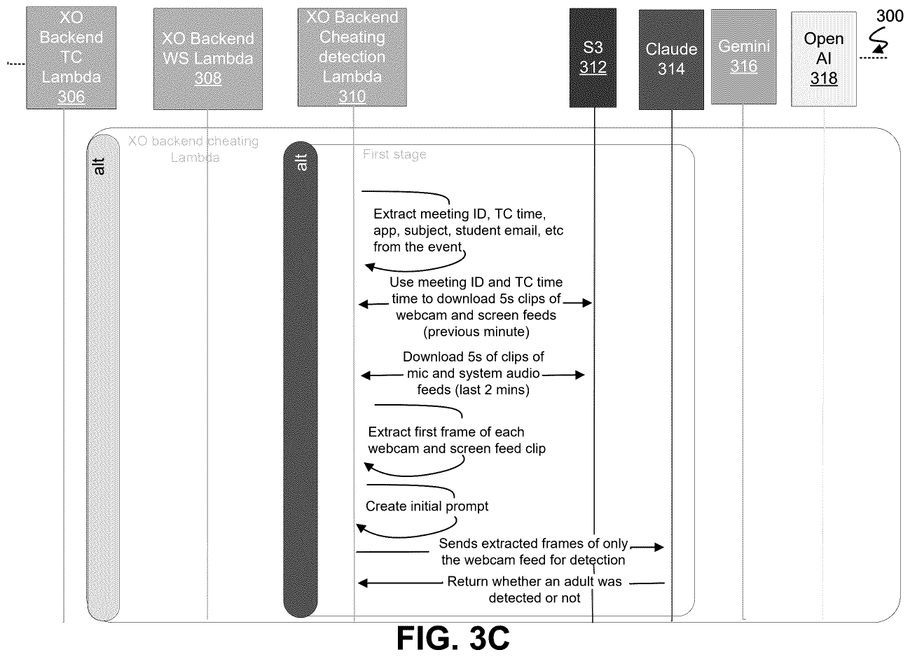

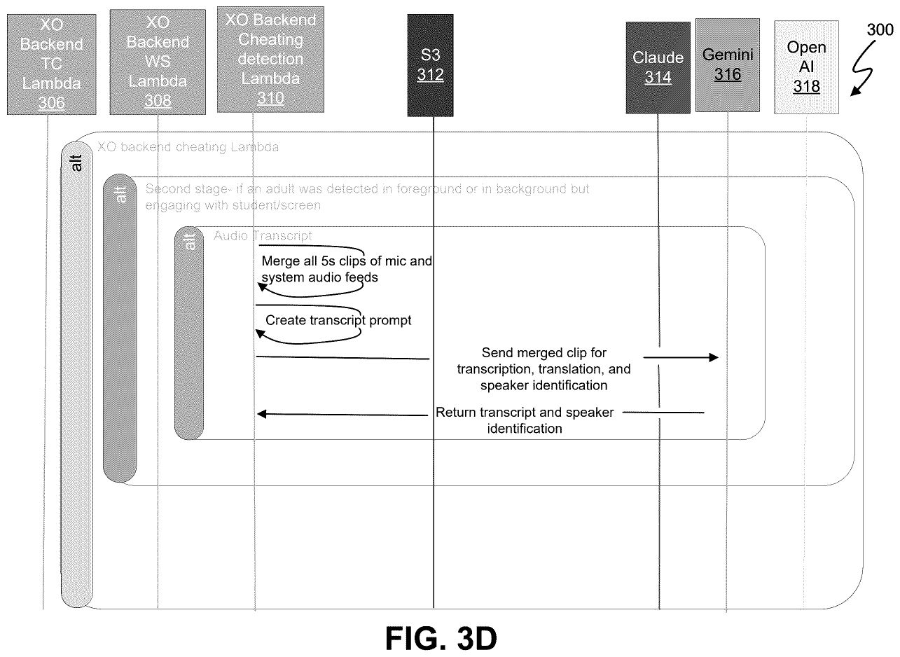

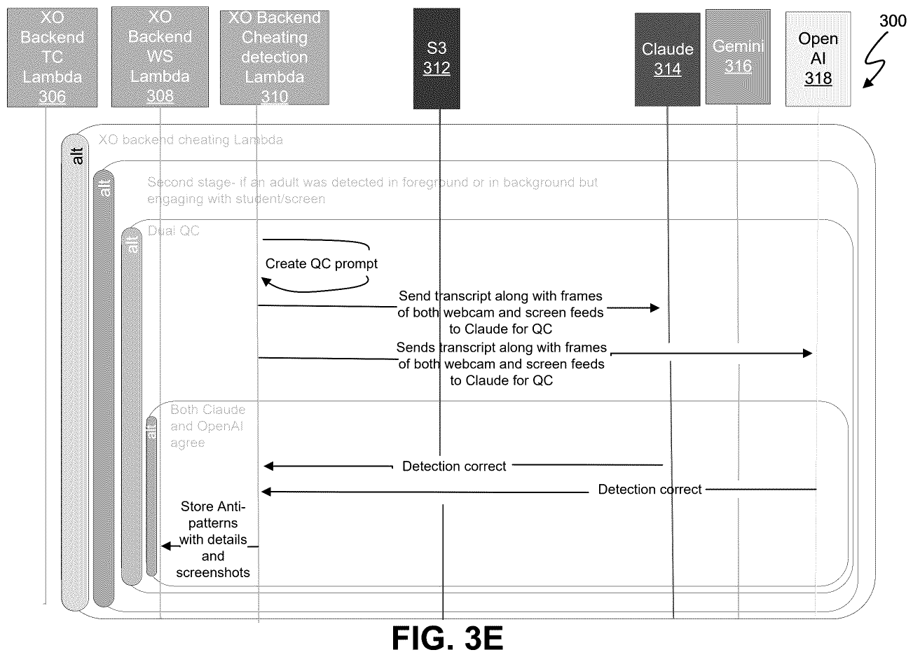

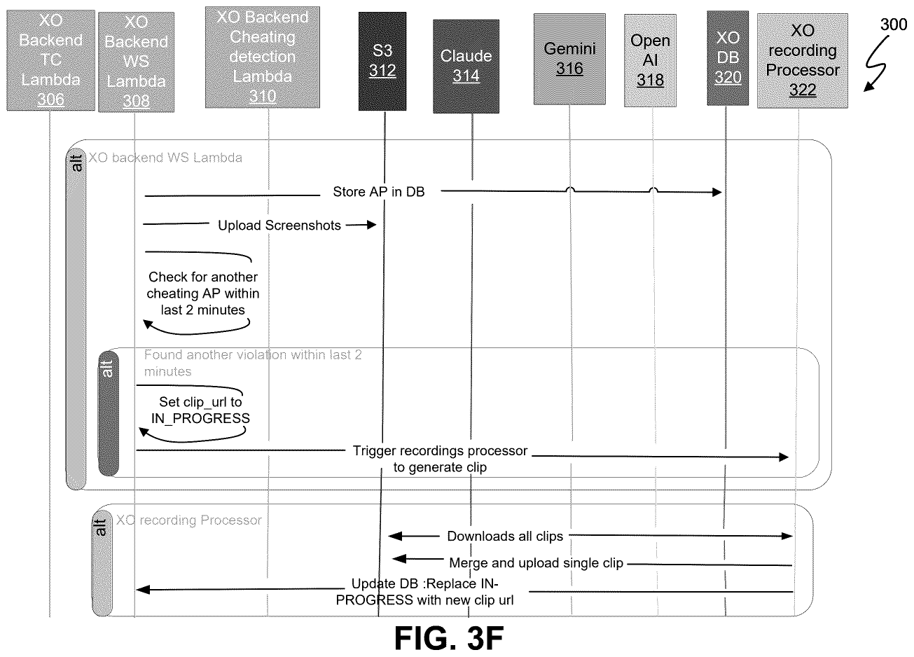

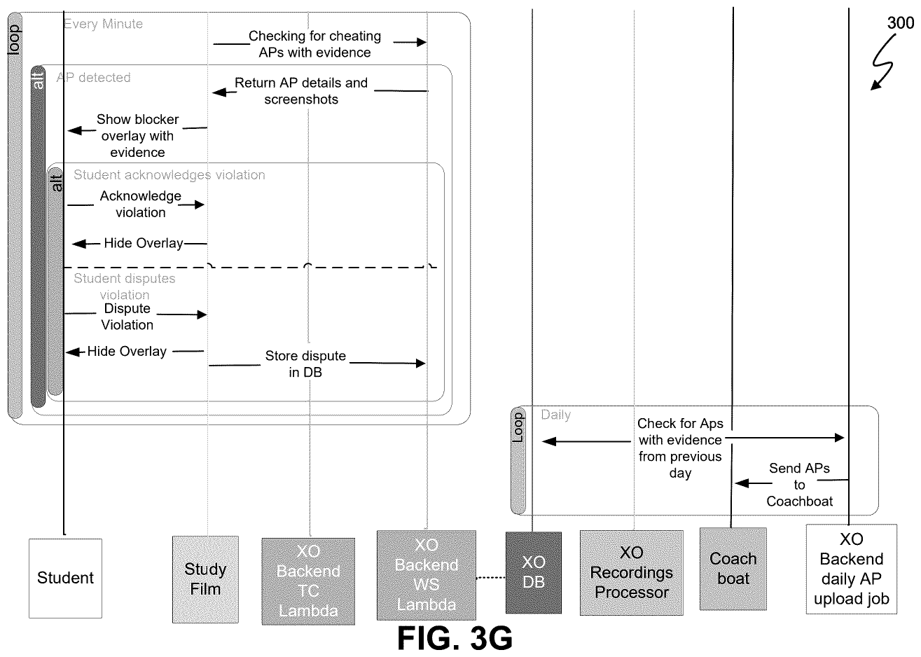

FIGS. 3A-3G collectively depict an exemplary StudyFilm cheating detection process 300 workflow that includes components involved in automatically generating, storing, and analyzing evidence clips, which is an embodiment of the real-time AI-based cheating detection process 200 of FIG. 2. The workflow starts with student 302 who is online and uses StudyFilm 304. Software tools such as AWS Chime that have recording features are used to record camera, microphone, and screen of the student 302. The StudyFilm 304 is a tool that sends the timecard 112 every minute with the URL activity of the student 302 to the crossover (XO) backend. It also uploads 5-second clips of the camera, microphone, and screen to the S3 312 database. The S3 312 is a scalable, secure, and high-speed storage service provided by Amazon Web Service (AWS). In every one minute, the StudyFilm 304 checks for the antipattern. If the antipattern is detected, then it checks evidence for the student 302 within the past 2 minutes. Once cheating is validated by the AI tools, the antipattern screenshot is then shared with student 302 as an overlay on the screen and a response is collected. The pseudocode for StudyFilm 304 is mentioned below:

### StudyFilm:

```
Function sendTimecard( ):
Every minute:
  urlActivity = getCurrentURL( )
  sendToBackend(“Timecard”, urlActivity)
```

```
Function sendClipsToS3( ):
Every 5 seconds:
  camClip, micClip, screenClip = getCurrentClips( )
  uploadToS3(camClip, micClip, screenClip)
```

```
Function checkForCheatingAP( ):
Every minute:
  cheatingAP = getCheatingAPFromBackend(last2Mins)
  if cheatingAP:
    showOverlay(cheatingAP)
```

```
Function showOverlay(cheatingAP):
showBlockerOverlay(cheatingAP.screenshots)
studentResponse = getStudentResponse( )
if studentResponse == “acknowledge”:
  hideOverlay( )
else if studentResponse == “dispute”:
  hideOverlay( )
  sendDisputeToBackend(cheatingAP)
```

The functions involved in this pseudocode are sendTimecard( ), sendClipsToS3( ), checkForCheatingAP( ), and showOverlay(cheatingAP). The function sendTimecard( ) includes sending URL activity to the crossover (XO) backend. The function sendClipsToS3( ) includes sending camera, microphone, and screen clips to the S3 312 database. The function checkForCheatingAP( ) performs checks every minute and if it finds the antipattern then it calls the function showOverlay(cheatingAP) that shows evidence to the student 302 and gets the response from the student as either ‘acknowledge’ or ‘dispute’. If the student 302 acknowledges violation, then hide the overlay. If the student disputes the violation, then hide the overlay and store the overlay in the XO database.

Once the timecard data reaches the crossover backend, it performs multiple checks. The crossover (XO) backend TC lambda 306 function initially checks if the data comes from the student 302 and if the student 302 is enrolled in the program. The student 302 registers in learn and earn program using their email ID; thus, the email ID is used to verify the student 302. The second check is to validate if URL activity contains allowed learning apps. Some exemplary allowed learning apps are Duolingo and Khan Academy which provide educational content for learning and practicing in different subjects. The third check is to investigate if the student 302 is idle or not. If the student 302 is idle, then the feeds are not captured. If all these checks return TRUE then crossover (XO) backend TC lambda 306 triggers a lambda function dedicated to cheating detection.

The pseudocode for the crossover (XO) backend TC lambda 306 function is mentioned below which includes the checks, isStudentEnrolled( ), isAllowedLearningApp(urlActivity) and isStudentActive( ).

XO Backend TC Lambda:

```
  Function handleTimecard(urlActivity):
    if isStudentEnrolled( ) and isAllowedLearningApp(urlActivity)
and isStudentActive( ):
      triggerCheatingDetectionLambda( )
```

The crossover (XO) backend TC lambda 306 function triggers a cheating specific lambda function on identifying an AP. This function is the XO Backend Cheating Detection Lambda 310. The cheating lambda extracts details such as meeting ID, timecard time, app URL, subject, and student email ID from the S3 312 database. It further uses meeting ID and timecard time to download the following from the S3 312 database:
a. All 5 seconds clips of the student's webcam and screen feeds within the last minute.
b. All 5 seconds clips of the microphone and system's audio feeds within the last 2 minutes.
   It extracts the first frame of each webcam and screen feed clip and sends the extracted frames of only the webcam feed to an AI tool such as Claude 3.5 Sonnet or Gemini Flash. An exemplary AI tool that is used in this case is Claude 3.5 Sonnet 314. A prompt is given to Claude 3.5 Sonnet 314 tool asking it to detect if there is an adult alongside the student 302 (either in the foreground or in the background, the adult should be looking at the student or screen or webcam). If Claude 3.5 Sonnet 314 detects no adult or an adult in the background not engaging with the student 302, then the process stops. If Claude detects an adult in the foreground or an adult in the background looking at the student 302 or screen or webcam, then all 5 seconds clips of the microphone and system's audio feeds are merged into a single clip and sent to another AI tool for transcription and translation along with speaker identification. The exemplary AI tool used in this case is Gemini 316 and it identifies if the speaker is a student, a computer, or an adult. The pseudocode for the cheating lambda function is mentioned below:

XO Backend Cheating Lambda:

```
  Function handleCheatingDetection( ):
    clips = downloadClipsFromS3(last2Mins)
    frames = extractFirstFrame(clips)
    detectionResult = askClaudeForDetection(frames.webcam)
    if detectionResult == “no adult” or detectionResult == “non-
engaging adult”:
      stop( )
    else:
      mergedAudioClip = mergeAudioClips(clips.audio)
      transcription =
getTranscriptionAndTranslation(mergedAudioClip)
      qcResult = askForQC(transcription, frames)
      if qcResult == “disagree”:
        stop( )
      else:
        storeCheatingAP(clips, frames, transcription)
```

The quality check (QC) stage in cheating lambda calls askForQC(transcription, frames) function. A QC prompt is created and the transcript along with frames of both webcam and screen feeds are sent to Claude 314 and OpenAI 318 for QC. The OpenAI 318 is another exemplary AI tool that is used in this case for quality checks. If either or both Claude 314 or OpenAI 318 disagree with the detection results, then the quality check process stops. If both agree that the detection result is correct, then a call to the crossover (XO) backend is made to store the AP for that specific minute with all details and screenshots.

The exemplary Large Language Model (LLM) used for detecting if an adult is present in the webcam feed frames is Claude 3.5 Sonnet 314, the LLM used for transcribing and translating the merged audio clips with speaker identification is Gemini 316 and the LLM used alongside Claude 314 for quality check (QC) to verify the detection results is GPT 4o of OpenAI 318. The prompt(s) 118 provided to Claude 3.5 Sonnet 314 is mentioned below:

```
“””
You are an expert online proctor with perfect vision and pay close
attention to detail. You are tasked with analyzing frames of the student's
webcam feed during an online learning session. Your goal is to determine
whether the student is learning alone or if someone else is present and
helping them.
Always consider the following conditions meticulously before making your
decision:
1. If there is only a single person (a student, who is not an adult)
visible in the webcam feed, the student is learning alone.
2. Apart from the student, if an adult is clearly and prominently visible
in the foreground, the student is not learning alone.
NOTE: If the student is seen sleeping or not looking at the screen/webcam,
it does not mean that they are not getting help and you should consider
them to be not learning alone as long as you detect that an adult is in the
foreground .
3. If the other person is a younger child (e.g., a younger sibling or
toddler), ignore their presence and consider the student to be learning
alone.
4. If there are people in the background, pay very close attention to
where they are looking:
4a. If they are not looking at the student or the screen/webcam, consider
the student to be learning alone
4b. If it can be ascertained with no less than 100% confidence that they
are looking at student or the screen/webcam, consider the student to be not
learning alone
5. If another person's face is not clearly and completely visible, the
student should be considered learning alone. Err on the side of caution to
avoid false categorization.
6. If no person is visible or webcam frames are black/obscured, the
student is to be given the benefit of doubt and is considered to be
learning alone.
I am not rooting for any particular outcome, ALL I want is the OBJECTIVE
TRUTH and COMPLETE ADHERENCE to ALL of the above guidelines - ACCURACY is
ALL THAT MATTERS.
Provide your analysis in a single response, using the following format:
  <verdict>
′IS_NOT_LEARNING_ALONE′ if an adult is present and helping the student,
otherwise ′IS_LEARNING_ALONE′.
  </verdict>
  <explanation>
Provide a concise explanation of your analysis, including any relevant
observations, reasoning, and conclusions drawn from the provided webcam
frames.
If you determine the student is not learning alone, explicitly mention the
presence of another person helping the student. Also mention if the other
person is an adult or a child and if they are in the foreground or
background.
  </explanation>
  <frames>
Share the indices of the frames you found to contain multiple individuals
to support your analysis (only those where there is an adult interacting
with the student or looking at the screen/webcam).
The frames are indexed from 0 to N−1, where N is the total number of frames
provided. They should be comma-separated without spaces.
If the student is learning alone, leave this section empty.
  </frames>
  Example response:
  <verdict>IS_LEARNING_ALONE</verdict>
  <explanation>
While there is an adult visible in a few frames, they are in the background
and it can be ascertained with only 90% confidence that they are looking at
student or the screen/webcam.
  </explanation>
  <frames>0,1,3,9</frames>
“””
```

The output expected from Claude 314 is the verdict-if the learner is alone or not. An explanation follows this verdict and if the verdict is ‘IS_NOT_LEARNING_ALONE’ then Claude 314 also returns the frames in which an adult is visible. The next step is the translation and transcription. The prompt(s) 118 for Gemini 316 is mentioned below:

“””
You need to transcribe the audio from all languages spoken in the audio
feed, and translate all of them to English. Identify each language and
speaker (student/adult/computer etc). If you cannot identify a speaker by
their voice, ALWAYS default to student and don't ever incorrectly tag a
voice as adult or computer if you are not 100% sure.
Example:
(Computer): [English] My house is...
(Student): [English] small
(Computer): [English] Those shirts are too small for...
(Student): [English] him
(Computer): [English] That woman is... than I am.
(Student): [English] older, older
(Another Child): [Hungarian] Gyere velem kártyázni
(Another Child): [English translation] Come play cards with me
(Computer): [English] The woman's shirt... big.
(Student): [English] has
(Adult): [Hungarian] Ez a rossz válasz, azt kell mondanod, hogy ″is″
(Adult): [English translation] That is the wrong answer, you need to say
″is″
“””

The expected output from the audio translation and transcription is the speaker and their corresponding English content. If the audio is not in English then LLM first translates the audio to English and then transcribes it. The next step in the process is the quality check process and the one or more prompt 118 is mentioned below:

“””
You are an expert image analysis decision verifier with perfect vision and
pay close attention to detail. You are provided with frames of the
student's webcam and screenshare feeds along with a transcript of the
microphone + system audio feed during an online learning session.
A preliminary analysis has already categorized this as an instance of an
adult being spotted alongside a student, and your job is to verify if the
preliminary analysis is correct and confirm whether there is an adult
clearly visible alongside the student and is helping the student with the
lesson or not.
Use the webcam feed to detect whether there is an adult helping the student
or not. Use the screenshare feed to understand what is happening on
screen, and correlate it with the audio transcript to further understand if
the student is getting help from an adult.
After confirming whether an adult is present alongside the student or not,
you will then verify whether the preliminary analysis VERY STRICTLY ADHERES
to ALL of the following criteria:
1. If there is only a single person (a student, who is not an adult)
visible in the webcam feed, the student is learning alone.
2. Apart from the student, if an adult is clearly and prominently visible
in the foreground, and the transcript clearly indicates that the adult is
either silent or talking about the lesson in progress, the student is not
learning alone.
NOTE: If the student is seen sleeping or not looking at the screen/webcam,
it does not mean that they are not getting help and you should consider
them to be not learning alone as long as you detect that an adult is in the
foreground regardless of the transcript.
3. If the other person is a younger child (e.g., a younger sibling or
toddler), ignore their presence and consider the student to be learning
alone.
4. If there are people in the background, pay very close attention to
where they are looking:
4a. If they are not looking at the student or the screen/webcam, consider
the student to be learning alone
4b. If it can be ascertained with no less than 100% confidence that they
are looking at student or the screen/webcam, consider the student to be not
learning alone if the transcript shows that the adult is talking about the
lesson in progress
5. If another person's face is not clearly and completely visible, the
student should be considered learning alone. Err on the side of caution to
avoid false categorization.
6. If no person is visible or webcam frames are black/obscured, the
student is to be given the benefit of doubt and is considered to be
learning alone.
If the preliminary analysis strictly follows ALL of the above guidelines,
your verdict should be IS_NOT_LEARNING_ALONE, else if it violates even one
guideline, it should be IS_LEARNING_ALONE
I am not rooting for any particular outcome, ALL I want is the OBJECTIVE
TRUTH and COMPLETE ADHERENCE to ALL of the above guidelines - ACCURACY is
ALL THAT MATTERS.
Provide your analysis in a single response, using the following format:
<verdict>
′IS_NOT_LEARNING_ALONE′ if an adult is present and helping the student,
otherwise ′IS_LEARNING_ALONE′.
</verdict>
<explanation>
Explain why you found the preliminary analysis to be correct or incorrect.
Provide a concise explanation of your analysis, including any relevant
observations, reasoning, and conclusions drawn from the provided webcam
frames.
If you determine the student is not learning alone, explicitly mention the
presence of another person helping the student. Also mention if the other
person is an adult or a child and if they are in the foreground or
background.
</explanation>
<frames>
Share the indices of the frames you found to contain multiple individuals
to support your analysis (only those where there is an adult interacting
with the student or looking at the screen/webcam).
The frames are indexed from 0 to N−1, where N is the total number of frames
provided. They should be comma-separated without spaces.
If the student is learning alone, leave this section empty.
</frames>
Example response:
<verdict>IS_LEARNING_ALONE</verdict>
<explanation>
The preliminary analysis is incorrect. While there is an adult visible in
a few frames, they are in the background and it can be ascertained with
only 90% confidence that they are looking at student or the screen/webcam.
The transcript also doesn't indicate any interaction related to the lesson
as it contains a conversation about eating whereas the screenshare feed
frames show that the lesson is about forests.
</explanation>
<frames>0,1,3,9</frames>
“””

The input provided with the prompt for the quality check process is a transcript along with frames of both webcam and screen feeds. The expected output is the verdict-whether the learner is alone or not alone followed by analysis results. It also reports frames, if the verdict is—‘IS_NOT_LEARNING_ALONE’.

The QC is performed by Claude 314 and OpenAI 318. If either or both Claude 314 and OpenAI 318 disagree with the detection then the process is not continued further. However, if both agree that the detection is correct, then the antipattern for that specific minute with all details and screenshots is stored.

Once a cheating antipattern is detected, the crossover (XO) backend triggers the WS lambda function. XO Backend WS Lambda 308 checks if there is another antipattern within the previous 2 minutes of the detected antipattern. If no violation is identified in the last 2 minutes, then AP is stored in the XO database 320. This XO database 320 stores all the antipatterns. However, if there is another violation identified within the last 2 minutes then AP is uploaded to the XO database 320 and screenshots are uploaded to S3 312 database. It also triggers the XO recordings processor 322 to merge all the clips of the webcam, screen, and microphone and the system's audio feeds of the student 302. The pseudocode for XO backend WS lambda 308 is mentioned below:

XO Backend WS Lambda:

```
Function handleCheatingAP(cheatingAP):
    if hasPreviousViolation(last2Mins):
      storeAPInDB(cheatingAP)
      uploadScreenshotsToS3(cheatingAP)
      callRecordingsProcessor( )
    else:
      storeAPInDB(cheatingAP)
  uploadScreenshotsToS3(cheatingAP)
```

The XO Backend WS Lambda 308 triggers the XO recordings processor 322 to merge all the clips. The XO recordings processor 322 downloads all the clips received within the last 2 minutes from the S3 312 database and merges them into a single clip. It then uploads the merged clip to the S3 312 database and calls XO Backend to replace the IN_PROGRESS with the URL of the current clip as the evidence in the XO database 320. The pseudocode for the XO recordings processor 322 is mentioned below:

XO Recordings Processor:

```
Function mergeAndUploadClips( ):
  clips = downloadClipsFromS3(last2Mins)
  mergedClip = mergeClips(clips)
  uploadToS3(mergedClip)
  updateDBWithClipURL(mergedClip.url)
```

After all the evidence are uploaded to the database, a job is run daily to report all the antipatterns of the previous day to the academic's team. The exemplary Coachbot 324 receives the APs with evidence from the daily AP upload job. The exemplary XO Backend Daily AP upload job 326 pseudocode is mentioned below:

Daily AP Upload Job:

```
Function dailyUploadJob( ):
  apsWithEvidence = getAPsFromDB(previousDay)
  sendToCoachbot(apsWithEvidence)
```

The high-level pseudo code for the overall process is mentioned below:

```
High-level Pseudocode for the algorithms:
function analyzeWebcam(feed):
  return detectPeople(feed)
function analyzeAudio(feed):
  return identifyMultipleVoices(feed)
function analyzeScreenCapture(feed):
  return detectAnomalies(feed)
```

```
High-level Pseudocode for the overall process:
while (sessionIsActive):
  video = captureWebcam( )
  audio = captureAudio( )
  screen = captureScreen( )
  if (analyzeWebcam(video) or analyzeAudio(audio) or
analyzeScreenCapture(screen)):
    storeEvidence(video, audio, screen)
    generateAlert( )
```

The pseudocode that shows the main function is mentioned below:

Function main( ):

startTask(sendTimecard)
startTask(sendClipsToS3)
startTask(checkForCheatingAP)
startTask(dailyUploadJob)

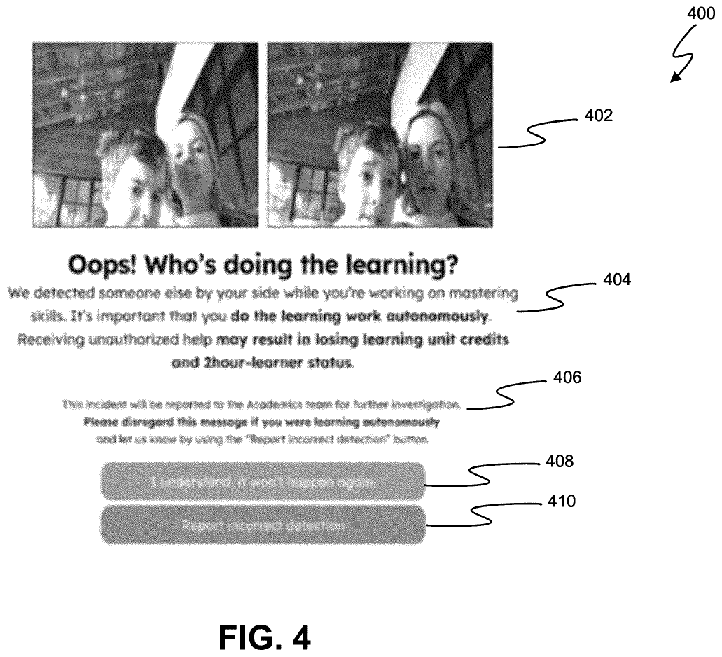

FIG. 4 depicts an exemplary snapshot of the learner's webcam which shows that the learner is assisted by an adult while working on mastering skills. The snapshot 402 shows a learner assisted by an adult. The learner is working on an academic platform and the adult is visible in the foreground. The antipattern is identified by the cheating process and an AI description 404 is generated. The AI description 404 along with the screenshot is shown as a blocker overlay to the student. The exemplary AI description is mentioned below:
Oops! Who's doing the learning?
We detected someone else by your side while you're working on mastering skills. It's important that you do the learning work autonomously. Receiving unauthorized help may result in losing learning unit credits and 2 hour-learner status

It also includes a disclaimer 406 below the AI description. The exemplary message is shown below:

This incident will be reported to the Academics team for further
investigation. Please disregard this message if you were learning
autonomously and let us know by using the “Report incorrect detection”
button.

Below the disclaimer, two options appear on the screen for the student. The student can select the exemplary option ‘I understand, it won't happen again.’ 408 if the student acknowledges the violation. The student can select the exemplary option ‘Report incorrect detection’ 408 if the student disputes the violation and wants to report the issue.

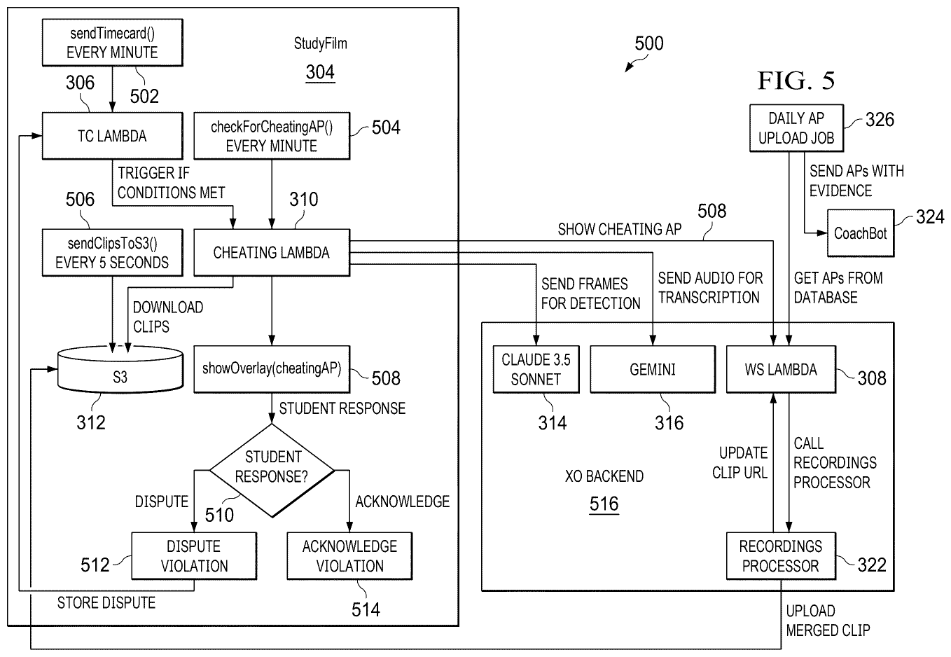

FIG. 5 depicts a StudyFilm cheating detection process 500 workflow that includes the function calls involved in automatically generating, storing, and analyzing evidence clips, which is an embodiment of the real-time AI-based cheating detection process 200 of FIG. 2. The figure depicts a StudyFilm 304 interface that interacts with an Artificial Intelligence based XO Backend 516 interface. The function, sendTimecard( )Every minute 502 involves sending the URL activity of the user to the function, TC Lambda 306 in intervals of 1 minute through a timecard. The function, TC Lambda 306 on receiving the URL initially performs few checks before invoking the Cheating Detection Lambda 310 function. The TC lambda 306 function checks if the URL data in the timecard is from the user's end. The TC lambda 306 function further checks if the user is enrolled in the correct learn and earn program and finally checks if the user is not idle. If the check performed by the TC Lambda 306 function returns a true response, then it triggers the Cheating Detection Lambda 310 function. The function sendClipsToS3( ) Every 5 seconds 506 gathers all the webcam, microphone, system audio, and screen share clips in intervals of 5 seconds and stores them in the S3 312 database.

The Cheating Detection Lambda 310 function extracts the meeting ID, the timecard time, the application URL, and the user email ID from the S3 312 database. Additionally, the Cheating Detection Lambda 310 function uses the meeting ID and the timecard time to download all the 5-second webcam and screen share feeds from the S3 312 database within the last minutes. It also downloads all the 5-second microphone and system audio feeds from the S3 312 database within the last 2 minutes. Then the Cheating Detection Lambda 310 function extracts the first frames of the webcam feed and the screen share feed and only shares the extracted webcam frames to an AI tool known as Claude 3.5 Sonnet 314 within the XO Backend 516 framework. The frames are shared with Claude 3.5 Sonnet 314 along with a prompt to detect the presence of another individual alongside the user. The individual could either be present in the background or the foreground of the user. If Claude 3.5 Sonnet 314 detects that no individual is present in the background or if the individual is present in the background but not interacting with the user or looking towards the webcam or screen, then the detection process is stopped. However, if Claude 3.5 Sonnet 314 detects that an individual is present in the foreground or if there is any individual in the background interacting with the user and looking at the screen or webcam, then all the 5-second clips of the microphone and system audio feeds are merged into a single clip. This merged clip is sent to another AI tool, Gemini 316 for translation and transcription along with a specific prompt.

Gemini 316 analyzes the merged clip to identify the speakers involved in the interaction. The speakers in the conversation may involve the user, the individual alongside the user, and the system audio. Gemini generates a transcript of the conversation with all interactions in languages other than English translated to English and tagged with their speakers. The Cheating Detection Lambda 310 function then sends the transcript generated by the Gemini 316 and the extracted frames of the webcam and screen share feeds along with a prompt for the quality check to two AI tools Claude 3.5 Sonnet 314 and Open AI 318. If both Claude 3.5 Sonnet 314 and Open AI 318 disagree with the results of the previous detections, then the cheating detection process stops. If both Open AI 318 and Claude 3.5 Sonnet 314 agree with the detections, then the Cheating Detection Lambda 310 function makes a call to the WS Lambda 308 function to store the antipattern 128 for that particular minute along with all clips and screenshots. The WS Lambda 308 function checks if there is an additional instance of cheating within the previous 2 minutes of the detected antipattern 128. If there are no instances of any detected antipattern 128 within the previous 2 minutes, then the antipattern 128 is stored in the evidence database 130. However, if there is an instance of detected antipattern, the WS Lambda 308 function triggers the recordings processor 322 to merge all the clips of the user's webcam, microphone, system audio and screen share feeds within the last 2 minutes. The merged clip along with the screenshots is uploaded to the S3 312 database. The WS Lambda 308 further triggers the recordings processor 322 to update the URL. The function checkForCheatingAP( ) Every minute 504 calls the Cheating Detection Lambda 310 function to check for the detection of antipattern 128 every minute. If the Cheating Detection Lambda confirms the detection of the antipattern 128 then it calls another function showOverlay(cheatingAP) 508. The function showOverlay(cheatingAP) 508 presents the evidence to the user, a student 302 in the form of a blocker overlay. This overlay appears on the user interface 106 and asks the user to respond to the presented evidence. Two options for the user appear on the screen as Student Response? 510. The first option for the user or student is to accept the detection as Acknowledge violation 514. The second option for the student is to disagree with the detection as Dispute violation 512. If the user accepts the violation, the overlay is concealed. If the user disputes the violation, then the overlay is concealed, and the TC Lambda 306 function is called again, and the disputed response is stored in the evidence database 130.

The WS Lambda 308 function also triggers a Daily AP Upload Job 326 process. This process ensures that the stored antipatterns 128 along with the evidence stored are gathered from the evidence database 130 and sent to a data lake named Coachbot 324 for further analysis by the academic team.

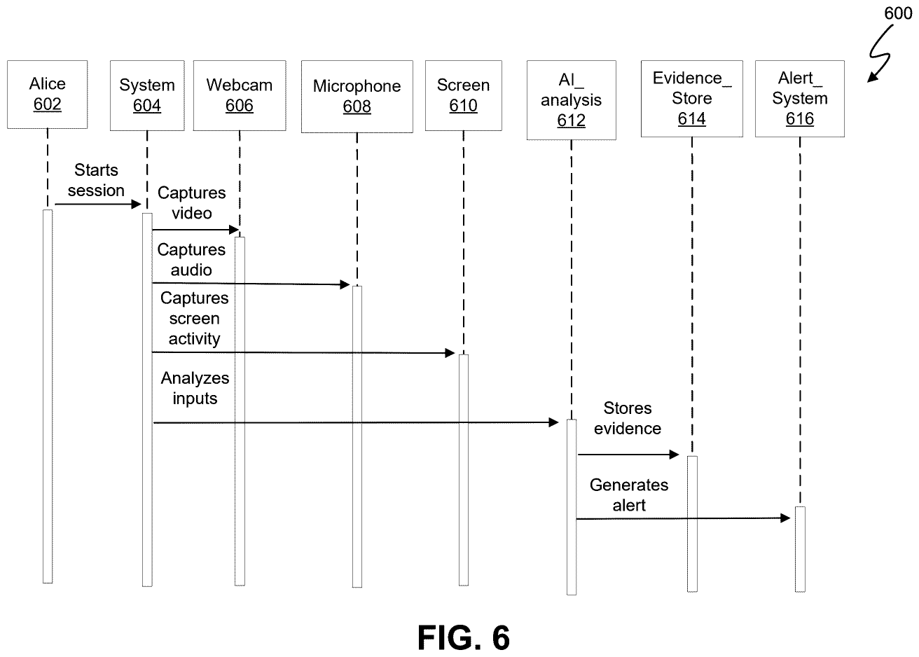

FIG. 6 depicts the sequence diagram 600 for generating alerts, which is an embodiment of the AI-based cheating detection process 200 of FIG. 2. A student, Alice 602, initiates the learning process on an online learning platform 104. The online learning platform 104 is integrated with the System 604. The System 604 denotes a software application or tool that interacts with data sources such as webcam, microphone and screen that are connected to the user device 102 during a live session. The System 604 collects the feed generated from the data sources and further leverages Artificial intelligence (AI) tools to analyze the input for detecting unauthorized assistance.

The system 604 interacts with the webcam 606 and captures the video feed. It further interacts with the microphone 608 and captures the audio feed. Additionally, the system 604 also interacts with Screen 610 of the user device 102 and captures the screen share activity feed. The system 604 then leverages AI tools and performs AI_Analysis 612 on the captured input feeds. If the AI_Analysis 612 on the input feeds detects unauthorized assistance, it triggers the generation of an evidence clip with timestamps. In addition to the evidence clip, a textual AI-generated description of the unauthorized assistance is generated. The evidence clip with a timestamp and the AI-generated description for the cheating detection are stored in the Evidence_Store 614. Finally, an alert system 616 is triggered which generates an alert that is displayed on the user screen with an overlay.

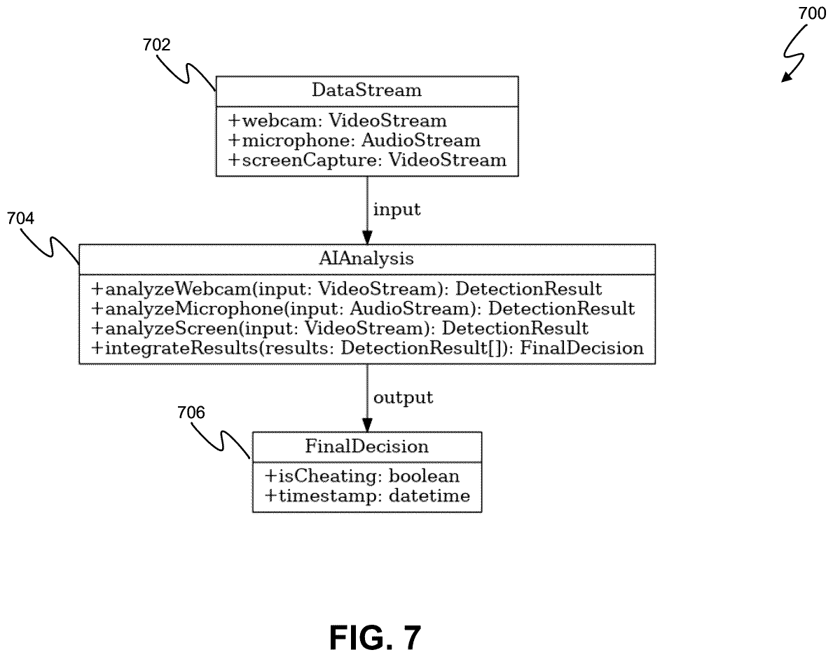

FIG. 7 depicts a data structure 700 for the detection of unauthorized assistance in online learning environments incorporating multimodal data analysis using webcam, microphone, and screen capture. The data extractor tool 108 gathers the DataStream 702. The DataStream 702 consists of the video data captured from the webcam and the screen capture. It also contains audio data captured from the microphone. This combined data acts as an input to the AIAnalysis 704 in which AI tools like Claude 3.5 Sonnet 314, Gemini 316 and Open AI 318 are used for analysis and identification of unauthorized assistance. The analyzeWebcam method analyzes the video data from the webcam. The analyzeMicrophone method analyzes the audio data from Microphone. analyzeScreen method analyzes the video data from the screen capture. The output generated through the AIAnalysis 704 is a cheating antipattern 128 along with the evidence clips and screenshots which is stored in an array DetectionResult. This output is displayed as FinalDecision 706 on the user interface 106. The FinalDecision 706 consists of variable isCheating that stores final result as boolean and variable timestamp that stores data in datetime format.

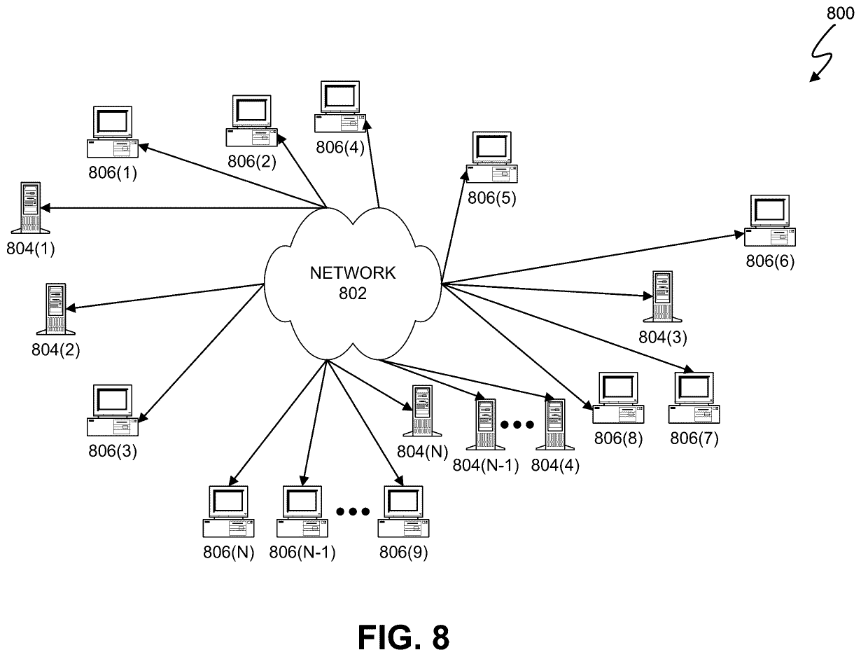

FIG. 8 is a block diagram illustrating a network environment in which real-time AI-based cheating detection systems 100 and process 200 that automatically generate and store evidence clips using webcam video, microphone audio, and screen capture feeds may be practiced. Network 802 (e.g. a private wide area network (WAN) or the Internet) includes several networked server computer systems 804(1)-(N) that are accessible by client computer systems 806(1)-(N), where N is the number of server computer systems connected to the network. Communication between client computer systems 806(1)-(N) and server computer systems 804(1)-(N) typically occurs over a network, such as a public switched telephone network over asynchronous digital subscriber line (ADSL) telephone lines or high-bandwidth trunks, for example, communications channels providing T1 or OC3 service. Client computer systems 806(1)-(N) typically access server computer systems 804(1)-(N) through a service provider, such as an internet service provider (“ISP”) by executing application-specific software, commonly referred to as a browser, on one of client computer systems 806(1)-(N).

Client computer systems 806(1)-(N) and server computer systems 804(1)-(N) are specialized computers programmed to improve conventional computer systems to implement and utilize real-time AI-based cheating detection systems 100 and process 200 that automatically generate and store evidence clips using webcam video, microphone audio, and screen capture feeds. The type of computer system that can be specially programmed to implement and utilize real-time AI-based cheating detection systems 100 and process 200 that automatically generate and store evidence clips using webcam video, microphone audio, and screen capture feeds includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the real-time AI-based cheating detection systems 100 and process 200 that automatically generate and store evidence clips using webcam video, microphone audio, and screen capture feeds can be implemented using code stored in a tangible, non-transient computer-readable medium and executed by one or more processors. In at least one embodiment, the real-time AI-based cheating detection systems 100 and process 200 that automatically generate and store evidence clips using webcam video, microphone audio, and screen capture feeds can be implemented completely in hardware using, for example, logic circuits and other circuits including field programmable gate arrays.

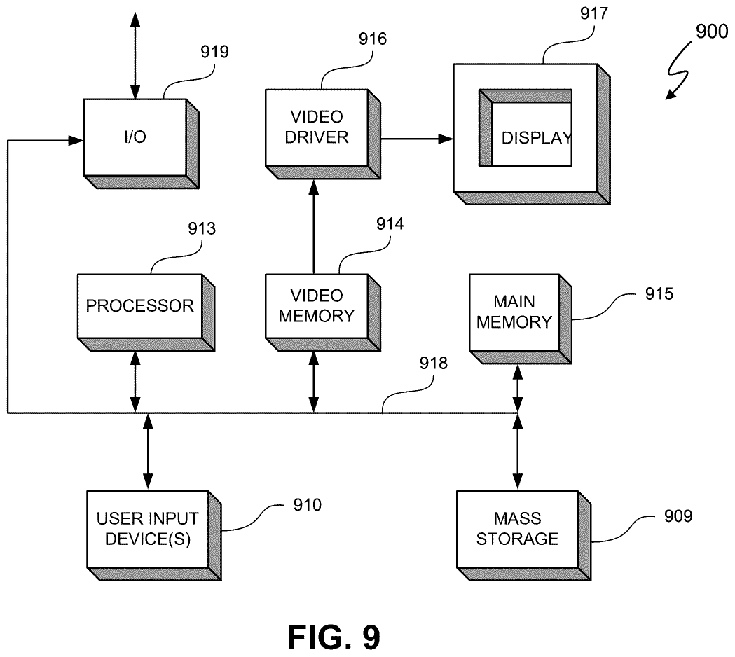

Embodiments of the real-time AI-based cheating detection systems 100 and process 200 that automatically generate and store evidence clips using webcam video, microphone audio, and screen capture feeds can be implemented on a computer system such as a special-purpose, special-programmed computer 900 illustrated in FIG. 9. Input user device(s) 910, such as a keyboard and/or mouse, are coupled to a bi-directional system bus 918. The input user device(s) 910 are for introducing user input to the computer system and communicating that user input to processor 913. The computer system of FIG. 9 generally also includes a non-transitory video memory 914, non-transitory main memory 915, and non-transitory mass storage 909, all coupled to bi-directional system bus 918 along with input user device(s) 910 and processor 913. The mass storage 909 may include fixed and removable media, such as a hard drive, one or more CDs or DVDs, solid state memory including flash memory, and other available mass storage technology. Bus 918 may contain, for example, 32 of 64 address lines for addressing video memory 914 or main memory 915. The system bus 918 also includes, for example, an n-bit data bus for transferring DATA between and among the components, such as CPU 909, main memory 915, video memory 914, and mass storage 909, where “n” is, for example, 32 or 64. Alternatively, multiplex data/address lines may be used instead of separate data and address lines.

I/O device(s) 919 may provide connections to peripheral devices, such as a printer, and may also provide a direct connection to a remote server computer system via a telephone link or to the Internet via an ISP. I/O device(s) 919 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 909, into main memory 915 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 913, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 915 consists of dynamic random access memory (DRAM). Video memory 914 is a dual-ported video random access memory. One port of the video memory 914 is coupled to the video driver 916. The video driver 916 is used to drive the display 917. Video driver 916 is well-known in the art and may be implemented by any suitable means. This circuitry converts pixel DATA stored in video memory 914 to a raster signal suitable for use by display 917. Display 917 is a type of monitor suitable for displaying graphic images.

The computer system described above is for purposes of example only. The real-time AI-based cheating detection systems 100 and process 200 that automatically generate and store evidence clips using webcam video, microphone audio, and screen capture feeds may be implemented in any type of computer system programming or processing environment. It is contemplated that the real-time AI-based cheating detection systems 100 and process 200 that automatically generate and store evidence clips using webcam video, microphone audio, and screen capture feeds might be run on a stand-alone computer system, such as the one described above. The real-time AI-based cheating detection systems 100 and process 200 that automatically generate and store evidence clips using webcam video, microphone audio, and screen capture feeds might also be run from a server computer systems system that can be accessed by a plurality of client computer systems interconnected over an intranet network. Finally, the real-time AI-based cheating detection systems 100 and process 200 that automatically generate and store evidence clips using webcam video, microphone audio, and screen capture feeds may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method for guiding an Artificial Intelligence (AI) Engine to detect unauthorized assistance to a user during an online learning session, the method comprises:
executing code using one or more processors of a computer system to cause the computer system to perform operations comprising:
receiving input data from a user device including one or more sources, wherein the one or more sources from where the input data is received include a video feed from a webcam, an audio from a microphone, and screenshots of a screen of the user's device;
pre-processing the received input data to validate that the user undergoing the online learning session is using a valid online learning platform, and is enrolled in a correct online learning program, wherein if the user passes the initial validation then the received input data are passed for further analysis;
providing one or more prompts via a prompt generator to the AI engine, wherein the one or more prompts guide and constrain the AI engine to virtually implement a plurality of AI tools and each AI tool is allocated an individual task;
analyzing the received input data for detecting the presence of unauthorized assistance using the plurality of AI tools configured to:
detect the presence of additional individuals in the video feed from the webcam using a visual recognition algorithm;
identify multiple voices or sounds indicating the unauthorized assistance using an audio analysis algorithm;
identify anomalies suggesting unauthorized assistance during the online learning session using a screen activity analysis algorithm;
compiling one or more pieces of evidence upon detection of the unauthorized assistance, wherein the one or more pieces of evidence include the video feeds of the corresponding timestamps, textual AI-generated description of the transcript of the online learning session; and
triggering an alert along with a transcript to the user, wherein the alert includes compiled evidence, and the transcript includes a summary of the detected behavior, one or more sources supporting the unauthorized assistance, and textual transcription of the corresponding timestamp where unauthorized assistance is detected.

2. The method of claim 1, wherein the received input data are stored in a cloud database.

3. The method of claim 1, wherein the input data are shared at a time interval of each 5 seconds for processing.

4. The method of claim 1, wherein the timestamp of the received input data is provided in the form of a URL and the details of the application used by the user are shared every minute for further processing.

5. The method of claim 1, wherein the plurality of AI tools includes a video feed and audio analysis tool, a transcript generation tool, and a quality check tool.

6. The method of claim 1, wherein analyzing the input data further comprises:
utilizing multimodal processing to simultaneously analyze the webcam, microphone, and screen capture data to detect patterns indicative of cheating; and
validating the detected anti-patterns using AI-based quality checks to ensure accuracy.

7. The method of claim 1, wherein the detection of the presence of additional individuals in the video feed further comprises:
detecting and classifying human faces based on their position on the screen, wherein the position on the frames includes foreground or background;
identifying behavioral patterns such as eye direction, body posture, and gestures indicating engagement of the user on their screen; and
flagging the unauthorized instance, if another person is detected in the foreground and interacting with the user.

8. The method of claim 1, wherein identifying multiple voices or sounds indicating the unauthorized assistance further comprises:
identifying distinct voices, and classifying them as the user, another person, speaker, or system;
detecting overlapping speech patterns suggesting real-time assistance or conversation with another person; and
generating the transcript of the detected speech, tagged with speaker identities, and timestamps for use as evidence.

9. The method of claim 1, wherein identifying anomalies suggesting unauthorized assistance further comprises:
detecting unauthorized applications or websites by analyzing the URLs used by the user; and
identifying anomalies in screen behavior, such as rapid switching between tabs, excessive mouse movement.

10. The method of claim 1 further comprises:
evaluating the presence of unauthorized assistance provided to the user during the online learning session simultaneously by utilizing different AI tools; and
validating the presence of the unauthorized assistance, if both the AI tools confirm the presence of the unauthorized assistance during the online learning session.

11. The method of claim 1, wherein the compilation of the one or more evidence for the detection of unauthorized assistance further comprises:
merging one or more short-duration clips from the webcam, microphone, and screen capture feeds into a single clip representing the unauthorized assistance evidence; and
translating the merged audio clips using AI algorithms with speaker identification to distinguish between the voice of the user, another person, system, or speaker.

12. The method of claim 1, wherein the complied evidence is stored in an evidence database for further review and intervention.

13. A system for guiding an Artificial Intelligence (AI) Engine to detect unauthorized assistance to a user during an online learning session comprises:
one or more processors of a computer system;
memory, coupled to the one or more processors, stores code that when executed by the one or more processors causes the computer system to perform operations comprising:
receiving input data from a user device including one or more sources, wherein the one or more sources from where the input data is received include a video feed from a webcam, an audio from a microphone, and screenshots of a screen of the user's device;
pre-processing the received input data to validate that the user undergoing the online learning session is using a valid online learning platform, and is enrolled in a correct online learning program, wherein if the user passes the initial validation then the received input data are passed for further analysis;
providing one or more prompts via a prompt generator to the AI engine, wherein the one or more prompts guide and constrain the AI engine to virtually implement a plurality of AI tools and each AI tool is allocated an individual task;
analyzing the received input data for detecting the presence of unauthorized assistance using the plurality of AI tools configured to:
detect the presence of additional individuals in the video feed from the webcam using a visual recognition algorithm;
identify multiple voices or sounds indicating the unauthorized assistance using an audio analysis algorithm;
identify anomalies suggesting unauthorized assistance during the online learning session using a screen activity analysis algorithm;
compiling one or more pieces of evidence upon detection of the unauthorized assistance, wherein the one or more pieces of evidence include the video feeds of the corresponding timestamps, textual AI-generated description of the transcript of the online learning session; and
triggering an alert along with a transcript to the user, wherein the alert includes compiled evidence, and the transcript includes a summary of the detected behavior, one or more sources supporting the unauthorized assistance, and textual transcription of the corresponding timestamp where unauthorized assistance is detected.

14. The system of claim 13, wherein the notifications including evidence and transcript are presented to the user on a user interface integrated within the online learning platform in which the user is undergoing the online learning session.

15. The system of claim 13, wherein the received input data is stored in a cloud database.

16. The system of claim 13, wherein the plurality of AI tools includes a video feed and audio analysis tool, a transcript generation tool, and a quality check tool.

17. The system of claim 13, wherein the analyzer allocates tasks to a plurality of AI tools for quality check, comprising:
the video feed and sound analysis tool to analyze the input data and detect the presence of unauthorized detection;
the transcript generation tool to generate the transcript of the timestamp of the online learning session where the unauthorized assistance is detected; and
the quality check tool to approve the presence of unauthorized assistance during the online learning session, if both tools used in the quality check validate the unauthorized detection.

18. The system of claim 13, wherein the complied evidence is stored in an evidence database for further review and intervention.

19. The system of claim 13, wherein the alert is triggered in real-time and the alert includes an overlay over the user's screen displaying the evidence and requiring an acknowledgment before continuing the online learning session again.

20. The system of claim 13, wherein the user can also submit a dispute in place of the acknowledgment, in case no assistance is provided to the user, for further review by the monitoring team.
